(19) United States
(12) Patent Application Publication
(10) Pub. No.: US 2008/0126919 A1
(43) Pub. Date: May 29, 2008

(54) Method, Apparatus and System for Managing Access to Multimedia Content Using Dynamic Media Bookmarks

(75) Inventors: Robert G. Uskali, Schaumburg, IL (US); Matthew J. Defano, Chicago, IL (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/557,598

(22) Filed: Nov. 8, 2006

(51) Int. Cl. G06F 17/00

(52) U.S. Cl. 715/200

(57) ABSTRACT

A method (30) and device (10) for accessing multimedia content. The method includes one or more end user multimedia devices receiving multimedia content, which may or may not include one or more dynamic bookmarks associated with particular portions of the multimedia content, e.g., portions of the multimedia content that have not been viewed or otherwise consumed by end user access devices. The method includes determining whether the received multimedia content includes an associated bookmark and providing access to the portion of the multimedia content identified by the bookmark. The method also includes generating new bookmarks or updating existing bookmarks based on end user consumption of the multimedia content by current or previous multimedia devices. The method also includes transferring multimedia content bookmarks alone or with associated multimedia content among multiple access devices, e.g., in various locations and in a number of suitable formats.

### BACKGROUND OF THE INVENTION

1. Field of the Invention

The invention relates to accessing multimedia content. More particularly, the invention relates to methods, apparatus and systems for accessing multimedia content seamlessly across multiple media access devices using dynamic media bookmarks.

1. Description of the Related Art

The ability to access multimedia content, such as video and/or audio content, can occur in multiple locations, from multiple access devices and in various content formats. For example, streaming video content and audio and/or video files can be accessed in the home or other locations by set-top boxes, computers and/or other media player devices. Similarly, such content can be accessed remotely by cellular telephones, handheld mobile devices and/or other mobile media access devices. Multimedia content can be accessed by the devices via a network or from other devices, e.g., via a wireline connection or through wireless access. Also, multimedia content can be transferred to and received by such devices in any one or more of a number of content formats, such as according to the Moving Pictures Experts Group (MPEG) 2 or MPEG 4 standards, according to any one or more of the H.26x line of coding or compression standards (e.g., the H.264 coding standard), or according to the MPEG-1 Audio Layer 3 (MP3) format.

Conventional media access devices and system arrangements typically require device end users to actively manage media access. That is, when an end user plays back, views or otherwise consumes a portion of the accessed content, subsequent access to the content, especially via a different device and/or in a different content format, is characterized by the lack of distinction between the portion of content already consumed, e.g., by the end user, and the remaining content portion that has yet to be consumed. Thus, the user's “place” in the playback or other consumption of the content is lost. The end user typically has to start over from the beginning of the accessed content and replay the content already consumed or actively scan by or jump ahead of content already consumed (e.g., using predefined “chapters” typically established by the content manufacturer or provider) to get to the beginning of the portion of content that has yet to be consumed. Such activity is time consuming, inefficient and does not make for a seamless user experience.

### BRIEF DESCRIPTION OF THE DRAWINGS

FIG. 1 is a block diagram of a multimedia device for use in a method and system for accessing multimedia content using dynamic media bookmarks;

FIG. 2 is a flow chart that schematically illustrates a method for a multimedia device to access media content using dynamic media bookmarks;

FIG. 3 is a diagram showing an example of accessing multimedia content across various multimedia devices using dynamic media bookmarks;

FIG. 4 is a diagram showing another example of accessing multimedia content across various multimedia devices using dynamic media bookmarks; and

FIG. 5 is a diagram showing yet another example of accessing multimedia content across various multimedia devices using dynamic media bookmarks.

### DETAILED DESCRIPTION

In the following description, like reference numerals indicate like components to enhance the understanding of the methods, apparatus and systems for accessing multimedia content using dynamic media bookmarks through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

The methods, apparatus and systems described herein involve the generation and use of dynamic multimedia bookmarks to provide an end user with relatively seamless access to and consumption of multimedia content using one or more multimedia content access devices. The use of multimedia bookmarks allows an end user to maintain their place in the progression of viewing or otherwise accessing and consuming multimedia content across one or more multimedia accessing devices and/or access locations and/or content formats, thus providing the user with a seamless experience.

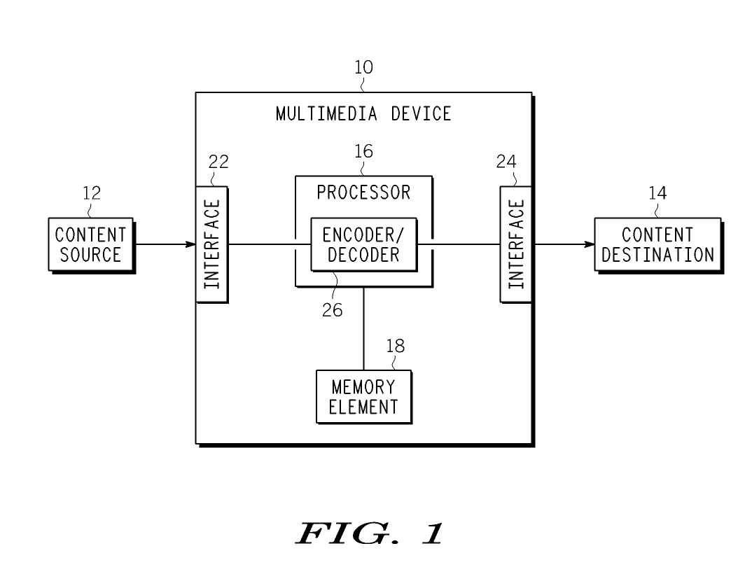

Referring now to FIG. 1, shown is a block diagram of a multimedia device 10 for use in a method and system for accessing multimedia content using dynamic media bookmarks. The multimedia device 10 can be any device for receiving multimedia content from a content source 12 and/or transmitting or transferring multimedia content to a content destination 14, such as a network or other multimedia devices. The multimedia content can be any suitable multimedia content, such as video content distributed as one or more video streams from a broadcast source, or audio content transferred wired and/or wireless from a network or from other multimedia devices.

Suitable multimedia devices include any multimedia content viewing, processing or storing device, such as any digital video recorder (DVR) or digital video server (DVS) device, including signal converter or decoder (set-top) boxes with internal and/or external recording capabilities and local and/or remote storage, which often are referred to as personal video recorder (PVR) devices. Other suitable multimedia devices include a residential gateway, a home media server system, a digital video disk recorder, a computer, a television with built-in or added-on video content receiving capability, or other suitable computing devices or video devices, including internet protocol (IP), satellite and cable digital video recorders, and home area network (HAN) systems. Other suitable content accessing devices include mobile or handheld mobile devices, such as a mobile telephone, a cellular telephone, a personal digital assistant (PDA), a laptop computer, a handheld computer and other mobile media access devices and handheld media access devices. The multimedia device also can be in the form of a wired or wireless network and/or devices incorporated into or coupled to the network, e.g., via a wired connection or wirelessly.

The multimedia device 10 includes a processor or processing unit 16 and a memory element or storage unit 18 coupled to the processor 16. The processor 16 is coupled between a first or input interface 22, which receives multimedia content from the content source 12, and a second or output interface 24, which transfers multimedia content to any suitable content destination 14, such as a network or other multimedia devices. It should be understood that the input interface 22 and the output interface 24 can be a single input/output interface coupled to the processor 16. The processor 16 includes an encoder/decoder 26 for locating bookmarks in multimedia content received by the multimedia device 10. The encoder/decoder 26 also can generate multimedia bookmarks and encode or otherwise associate the bookmarks with various portions of or positions within multimedia content, as will be discussed in greater detail hereinbelow.

One or more of the processor 16 (including the encoder/decoder 26), the memory element 18 and the interfaces 22, 24 can be comprised partially or completely of any suitable structure or arrangement, e.g., one or more integrated circuits. Also, it should be understood that the multimedia device 10 includes other components, hardware and software (not shown) that are used for the operation of other features and functions of the device 10 not specifically described herein.

The multimedia device 10 can be partially or completely configured in the form of hardware circuitry and/or other hardware components within a larger device or group of components. Alternatively, the multimedia device 10 can be partially or completely configured in the form of software, e.g., as processing instructions and/or one or more sets of logic or computer code. In such configuration, the logic or processing instructions typically are stored in a data storage device, e.g., the memory element 18 or other suitable data storage device (not shown). The data storage device typically is coupled to a processor or controller, e.g., the processor 16 or other suitable processor or controller (not shown). The processor accesses the necessary instructions from the data storage device and executes the instructions or transfers the instructions to the appropriate location within the multimedia device 10.

The memory element 18 can be any suitable information storage unit, such as any suitable magnetic storage or optical storage device, including magnetic disk drives, magnetic disks, optical drives, optical disks, and memory devices, including random access memory (RAM) devices, read-only memory (ROM) and flash memory. Also, although the memory element 18 is shown within the multimedia device 10, the memory element 18 can be located external to the multimedia device 10 and suitably coupled thereto.

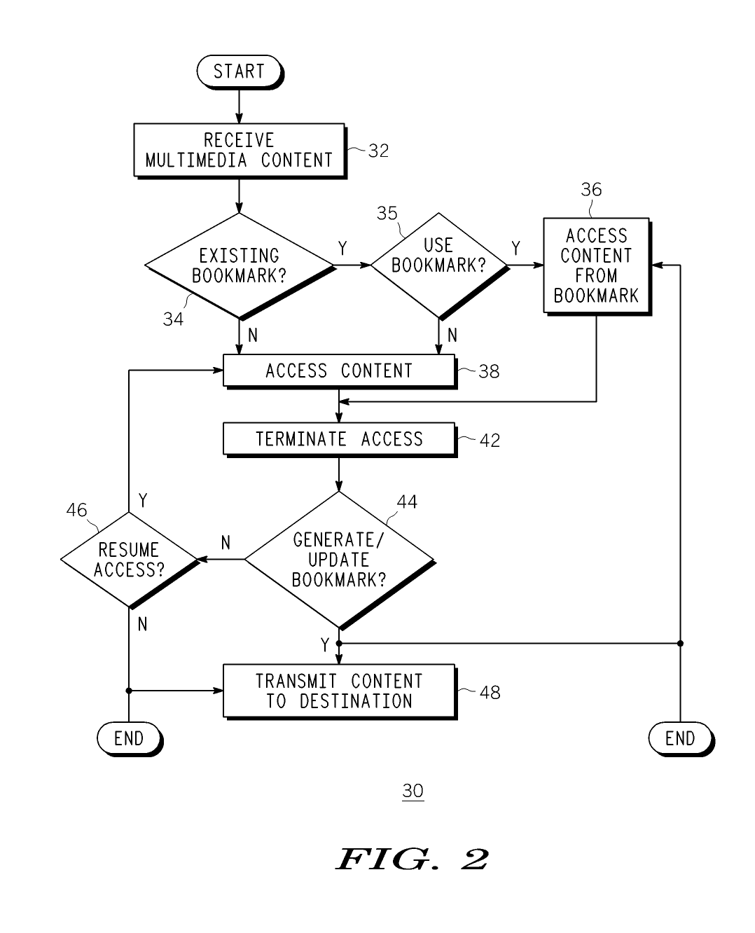

Referring now to FIG. 2, with continuing reference to FIG. 1, shown is a flow chart that schematically illustrates a method 30 for a multimedia device, such as the device 10, to access multimedia media content using dynamic media bookmarks. For purposes of discussion herein, a bookmark is a piece of data, generated by an end user or based on end user input, that indicates or points to a position or time in a multimedia content file or stream.

The method 30 includes a step 32 of a multimedia device 10 receiving multimedia content. The received multimedia content typically is received from the content source 12 by the input interface 22 and transferred to the processor 16. The processor 16 reads the received content and can store it in the memory element 18 or other suitable location, such as a buffer or other temporary storage location.

As discussed generally hereinabove, multimedia content can be streaming audio and/or video content. alternatively, multimedia content can be in a non-streaming format, e.g., a digital video disk (DVD), one or more video files and/or audio files, such as an MP3 file. The multimedia content received by the access device 10 typically is in the form of a multimedia video and/or audio stream comprised of a plurality of digital video and/or audio signals formatted according to a suitable standard, such as the Moving Pictures Experts Group (MPEG) 2 or MPEG 4 standards, one or more of the H.26x line of coding or compression standards (e.g., the H.264 coding standard), or according to the MPEG-1 Audio Layer 3 (MP3) format. As will be understood from further discussion hereinbelow, the content access devices involved in receiving, consuming and/or transferring multimedia content are configured to read and process multimedia content in one or more suitable formats, and configured to transfer, if necessary, multimedia content in a format suitable to be read and consumed by the multimedia device receiving the multimedia content. That is, one or more of the content access devices discussed herein are configured to perform transcoding, e.g., conversion from one content format to at least one other content format, such as from MPEG 2 to MPEG 4.

For set-top boxes, DVRs and other multimedia content access devices that typically reside in the home or other location of the end user, the multimedia content often is delivered to the access device 10 by a digital cable system, such as a Hybrid Fiber Coaxial (HFC) cable system, or other suitable video stream source delivery system. The video stream also can be an analog video stream, or an Internet Protocol (IP) video stream transmitted over any suitable Fiber To The Premises (FTTP) system, such as Fiber To The Curb (FTTC) or Fiber To The Home (FTTH), or over any suitable number of digital subscriber line systems (xDSL). Other access devices 10, such as home computers and computer-related devices, can receive multimedia content via a computer network, either through a wired connection or wirelessly. Still other access devices, such as mobile access devices, including PDAs and cellular telephones, can receive multimedia content, e.g., wirelessly, from a network and/or from one or more other content access devices.

The method 30 also includes a step 34 of determining whether the received multimedia content has one or more bookmarks or media bookmarks associated with one or more portions or segments of the received multimedia content. For example, within the multimedia device 10, the encoder/decoder 26 or other suitable portion of the processor 16 is configured to read the received multimedia content and determine whether one or more bookmarks are contained within or associated with the received content.

According to the method 30, bookmarks can have any suitable form and/or be in any suitable format for indicating or pointing to a position or time in a multimedia content file or stream. For example, one or more bookmarks can be integrated or embedded within the multimedia content, e.g., as one or more start/stop codes, to identify or represent one or more various portions or relative positions within the multimedia content, i.e., a relative position or elapsed time period within the multimedia content. For example, one or more bookmarks can be embedded within the header portion of the multimedia content, e.g., in a conventional manner and according to a conventional format.

Alternatively, according to the method 30, one or more of the bookmarks can be associated with the multimedia content, e.g., as metadata. In general, within the context of multimedia content, metadata refers to information that describes multimedia content in such a way that the multimedia content can be catalogued, indexed, archived and/or retrieved at some future date. Also, one or more of the bookmarks can be part of one or separate files that are associated with the multimedia content, e.g., an Extensible Markup Language (XML) file, which typically is a text-based file that can be used to describe content or data contained in another associated file.

According to the method 30, the encoder/decoder 26 or other suitable portion of the processor 16 associates a bookmark with a particular portion of multimedia content, i.e., the beginning of a particular content segment, or a relative position within the multimedia content. As will be discussed in greater detail hereinbelow, bookmarks are used to identify, e.g., the beginning of a portion of the multimedia content that has not been viewed, played or otherwise consumed by an end user, e.g., via the multimedia device currently receiving the multimedia content or via another access device that previously received the multimedia content. Bookmarks serve as a starting point for random access into the multimedia content at the appropriate point.

According to the step 34, if the multimedia content received by the access device 10 includes a bookmark or has a bookmark associated therewith, the end user can make use of the existing bookmark (shown as a step 35) to have the device 10 access the multimedia content at the starting point identified by the bookmark, shown as an access step 36. If the end user does not want to make use of the existing bookmark, or if the multimedia content received by the access device 10 does not include a bookmark or does not have a bookmark associated therewith, the device 10 typically can access the multimedia content from any suitable location according to the normal operation of the device 10, which is shown as an access step 38. For example, the device 10 can access the content from the beginning of the content or from one or more predefined “chapters” typically established by the content manufacturer or provider.

The method 30 also includes a step 42 of the access device 10 terminating access to the multimedia content. Access devices 10 typically are configured to pause or terminate the viewing, playback or other form of consumption of the multimedia content at any suitable point during the viewing or playback. Alternatively, the access device 10 can terminate access to the multimedia content if the entire portion of the multimedia content has been viewed or played.

The method also includes a step 44 of the access device 10 determining if one or more bookmarks are to be generated for associated multimedia content or if one or more existing bookmarks associated with multimedia content are to be replaced by or updated with one or more new bookmarks. For example, if an end user begins viewing multimedia content received by the end user's access device but terminates access, temporarily, before viewing or otherwise consuming the entire content file, the end user can instruct the access device 10 to generate a bookmark associated with the multimedia content that will mark the place in the multimedia content between the portion of the multimedia content that has been viewed or consumed by the end user and the portion of the multimedia content that has not been consumed by the end user. In this manner, the bookmark will identify a likely possible starting position of any subsequent consumption of the multimedia content. As discussed previously herein, the bookmark can have any suitable form and/or be in any suitable format for indicating or pointing to a position or time in a multimedia content file or stream.

Similarly, if the end user resumes the viewing or consumption of multimedia content from an existing bookmark but terminates access, temporarily, before viewing or otherwise consuming the entire content file, the end user can instruct the access device 10 to update the existing bookmark associated with the multimedia content. The updated bookmark will replace the previous bookmark to mark or identify the new location in the multimedia content between the portion of the multimedia content that has been viewed or consumed by the end user and the portion of the multimedia content that has not been consumed by the end user. The updated bookmark typically is in the same form or format as the previous bookmark, although such is not necessary.

According to the step 44, if a new bookmark is not generated or an existing bookmark not updated, and the entire multimedia content has not been viewed or consumed, a step 46 of determining whether to resume access to the content can be performed. For example, if an end user pauses or temporarily stops the viewing or playback of the multimedia content, the end user can resume playback of the multimedia content from the point where the multimedia content was paused or temporarily stopped. Alternatively, the end user can resume playback of the multimedia content from the beginning if the end user wants to completely view or consume again the multimedia content.

Also, if the end user does not want to resume access to the content, the method 30 can terminate access with respect to that particular multimedia content. Alternatively, the access device 10 can perform a step 48 of transferring or transmitting all or a portion of the multimedia content to another destination, such as to a network or to another access device, e.g., as will be discussed in greater detail hereinbelow.

Also, according to the step 44, if a new bookmark is generated or an existing bookmark is updated, and the entire multimedia content has not been viewed or consumed, the step 36 of accessing the multimedia content from the previously-established bookmark can be performed, e.g., if the end user wants to view or consume again the portion of the multimedia content just consumed. Also, alternatively, the method 30 can terminate access with respect to that particular multimedia content. Also, alternatively, the access device 10 can perform the step 48 of transferring or transmitting all or a portion of the multimedia content to another destination, such as to a network or to another access device.

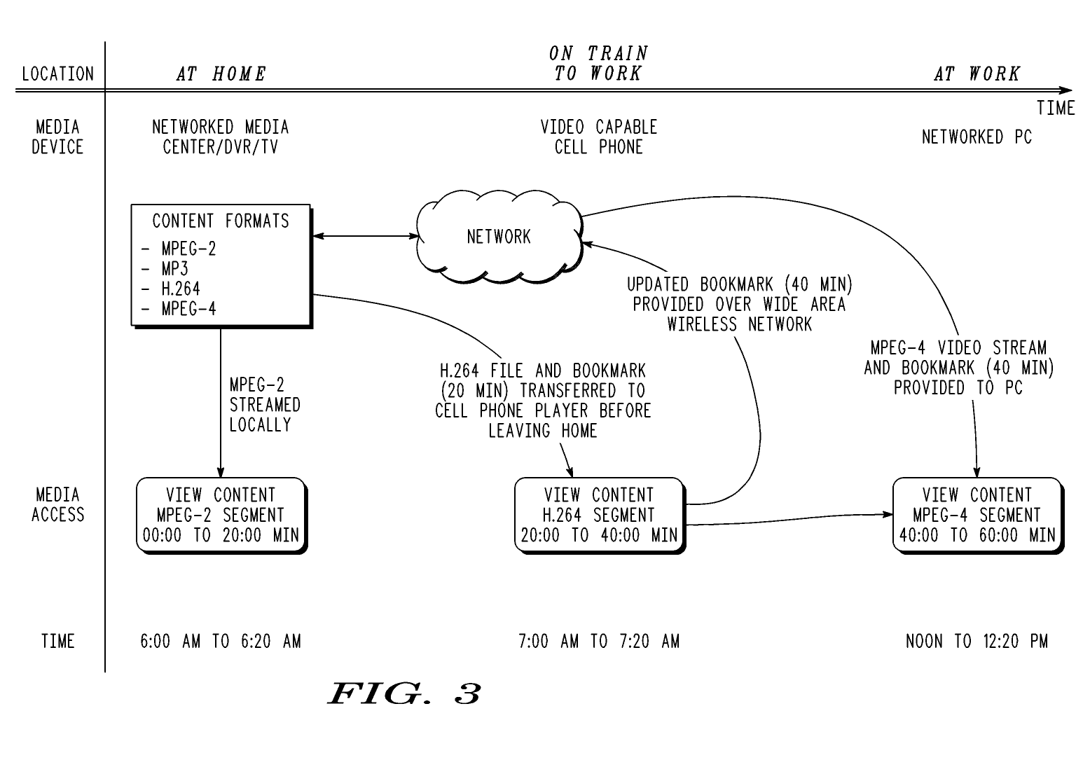

Referring now to FIG. 3, shown is a block diagram of an example scenario of accessing multimedia content across various multimedia devices using dynamic media bookmarks. The illustrated scenario involves an end user initially receiving multimedia content, such as a 1-hour video program, at home via an end user's networked media center, e.g., a DVR for receiving and recording the video program and a television for viewing the recorded video program. That is, the end user's networked media center is the initial multimedia device in this example. The video program can be broadcast or downloaded from any suitable content source, e.g., a network, to the end user's networked media center. As shown, the video program can be streamed locally to the end user's networked media center in one or more formats, including MPEG-2, MP3, H.264 and MPEG-4. In this example, at 6:00 AM, the end user initially consumes (e.g., views) a first portion of the video program, e.g., the first 20 minutes of the video program, from 6:00 AM to 6:20 AM, in a suitable format, e.g., MPEG-2, using the television connected to the end user's networked media center.

After the end user views the first 20 minutes of the video program, the end user instructs the networked media center to bookmark the video program at the point between the 20-minute segment just viewed and the remaining 40 minutes of the video program not yet viewed. As discussed previously herein, the bookmark can be embedded in the video program as one or more access codes, such as start or stop codes in the stream of the video program. Alternatively, the bookmark can be in the form of metadata that is otherwise associated with the video program.

The end user then instructs the networked media center to transfer a copy of all (1 hour) or a portion (e.g., the remaining 40 minutes of unviewed content) of the video program and the associated bookmark to another content access device, such as the end user's cellular telephone, which is configured to be video-capable. The transfer can be performed in any suitable manner, e.g., wirelessly or via a wired connection between the end user's networked media center and the cellular telephone. It should be understood that the portion of the video program transferred to the end user's cellular phone is in a format suitable to be read and accessed by the cellular telephone, e.g., a format according to the H.264 standard.

Also, the video program and the associated bookmark can be transferred to the network for subsequent access by one or more other content access devices. In FIG. 3 and subsequent FIGS., although some connections between devices or elements are shown as direct connections (e.g., a docking station for a cell phone that is coupled to a network media center), such connections can use a network, such as a local area network (LAN), a wide area network (WAN), and/or a cellular telephone network. Also, any connections shown using a network can be accomplished through a direct connection, and any direct connection can be implemented using a network.

Alternatively, the end user may only transfer a copy of the portion of the video program that has yet to be viewed. However, if the end user only transfers the portion of the video program that has yet to be viewed, the end user may not be able to view again the first segment of the video program that already has been viewed, unless the first segment of the video program previously was stored or subsequently is transferred to the appropriate content access device, which, at this point in time, now is the end user's cellular telephone.

In this example, at 7:00 AM, the end user consumes (e.g., views) a second portion of the video program, e.g., the next 20 minutes of the video program, e.g., from 7:00 AM to 7:20 AM, in a suitable format, e.g., H.264, using the end user's cellular telephone. Since the bookmark between the first 20-minute segment already viewed and the remaining 40 minutes of the video program was transferred from the end user's networked media center to the end user's cellular telephone, the end user was able to access (via the end user's cellular telephone) the remaining, unviewed portion of the video program immediately and automatically. Conventionally, an end user would not have any indication of where any previous viewing had terminated and where to subsequently access the as-yet unviewed portion of the video program.

After the end user viewed the second (20-minute) segment of the video program, the end user instructs the cellular telephone to bookmark the video program at the point between the first 40-minute portion of the video program already viewed and the remaining 20 minutes of the video program not yet viewed. The bookmark is dynamic, e.g., in that it effectively can be moved to or associated with a different point in the video program by being updated. Alternatively, a new bookmark can be generated for this portion of the content.

The end user then instructs the cellular telephone to transmit or transfer the updated bookmark to the network, e.g., either alone or along with at least a portion of the video program or a copy of the video program. That is, the bookmark can be transferred along with or independent of its associated multimedia content. The access device transfers the information in any suitable manner, e.g., wirelessly or via a wired connection between the end user's cellular telephone and the network.

Also, the end user can instruct the cellular telephone to transmit or transfer all or a portion of the video program or a copy of the video program, alone or along with its associated (updated) bookmark, to another multimedia content access device, e.g., a networked desktop or personal computer located in the work location of the end user. The transfer is performed in any suitable manner, e.g., wirelessly or via a wired connection between the end user's cellular telephone and the network. Alternatively, the end user can use the networked computer to retrieve a copy of all or a portion of the video program and the updated bookmark from the network, rather than receiving it from the end user's cellular telephone.

In this example, at 12:00 noon, the end user next consumes (e.g., views) a third and, in this example, final portion of the video program, e.g., the remaining 20 minutes of the video program, e.g., from 12:00 noon to 12:20 PM, in a suitable format, e.g., an MPEG-4 video stream, using the end user's networked computer at the end user's work location. As before, with the updated bookmark identifying or representing the location in the video program between the 40-minute portion of the video program already viewed and the remaining 20 minutes of the video program, the end user's access device, e.g., the networked computer, is able to immediately and automatically access the 20-minute unviewed portion of the video program.

Although the three video segments of the video program in this example are each 20 minutes in length, it should be understood that any one or more of the video program segments can be any suitable length of time and that the video program segments do not have to be the same length of time nor lengths of time that are multiples of one another. Moreover, the total number of viewing segments is not limited to three or any other number.

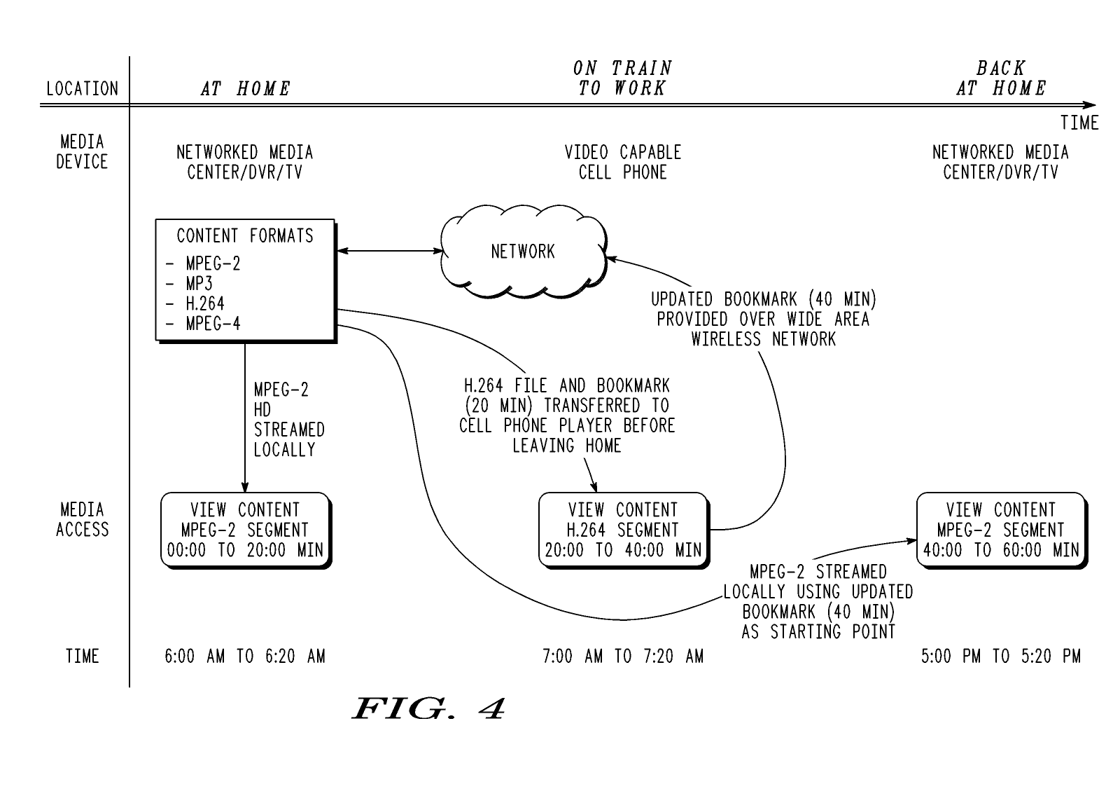

Referring now to FIG. 4, shown is a block diagram of another example scenario of accessing multimedia content across various multimedia devices using dynamic media bookmarks. This particular scenario involves an end user initially receiving multimedia content, such as a 1-hour video program, at home via an end user content access device, such as the end user's networked media center. The video program is broadcast or downloaded from a network or other suitable content source to the end user's networked media center. In this example, the video program is streamed locally to the end user's networked media center in one or more formats, including MPEG-2, MP3, H.264 and MPEG-4.

In this particular example, at 6:00 AM, the end user consumes (e.g., views) a first portion of the video program, e.g., the first 20 minutes of the video program, from 6:00 AM to 6:20 AM, in a suitable format, e.g., MPEG-2, using the television connected to the end user's networked media center. After the end user views the first 20 minutes of the video program, the end user instructs the networked media center to terminate access to the video program and to bookmark the video program at the point between the 20-minute segment just viewed and the remaining 40 minutes of the video program not yet viewed.

The end user then instructs the networked media center to transfer a copy of at least a portion of the video program (e.g., the remaining 40 minutes of unviewed content) and the associated bookmark to another content access device, such as the end user's video-capable cellular telephone. The transfer is performed in any suitable manner, e.g., wirelessly or via a wired connection between the end user's networked media center and cellular telephone. As discussed previously herein with respect to the previous example, the transferred portion of the video program is transferred to the end user's cellular phone in a format suitable to be read and accessed by the cellular telephone, e.g., a format according to the H.264 standard. Also, the end user can instruct the networked media center to transfer all or a portion of the video program and the associated bookmark to the network for subsequent access by one or more other content access devices.

Next, in this example, at 7:00 AM, the end user consumes (e.g., views) a second portion of the video program, e.g., the next 20 minutes of the video program, e.g., from 7:00 AM to 7:20 AM, in a suitable format, e.g., H.264, using the end user's cellular telephone. Access to the beginning of the remaining 40-minute portion of the video program that up until then had not been viewed by the end user is available immediately and automatically to the end user's cellular telephone because of the bookmark between the first 20-minute segment already viewed and the remaining 40 minutes of the video program that up until then had not been viewed. As discussed previously, the bookmark can be embedded in the video program to identify the appropriate position in the video program or, alternatively, can be otherwise associated with such position, e.g., in the form of metadata.

After the end user views the second (20-minute) segment of the video program, the end user instructs the cellular telephone to bookmark the video program at the point between the first 40-minute portion of the video program already viewed and the remaining 20 minutes of the video program not yet viewed. The end user also instructs the cellular telephone to transmit or transfer the updated bookmark to the network, e.g., either alone or along with at least a portion of the video program or a copy of the video program. The transfer of the bookmark and/or the video program is performed in any suitable manner, e.g., wirelessly or via a wired connection between the end user's cellular telephone and the network.

In this example, at 12:00 noon, the end user consumes (e.g., views) the remaining 20-minute portion of the video program that had yet to be viewed, e.g., from 12:00 noon to 12:20 PM, in a suitable format, e.g., MPEG-2, again using the television connected to the end user's networked media center. The video program and the updated bookmark is available to the end user's networked media center via an MPEG-2 stream from the network, as shown. Alternatively, if the end user's networked media center had previously recorded or otherwise stored a copy of the video program, the end user's networked media center can obtain just the updated bookmark from the network, or other suitable access device (e.g., the end user's cellular telephone), for use with the copy of the video program already stored in the networked media center. Using the updated bookmark, the end user's networked media center is able to immediately and automatically access the unviewed portion of the video program.

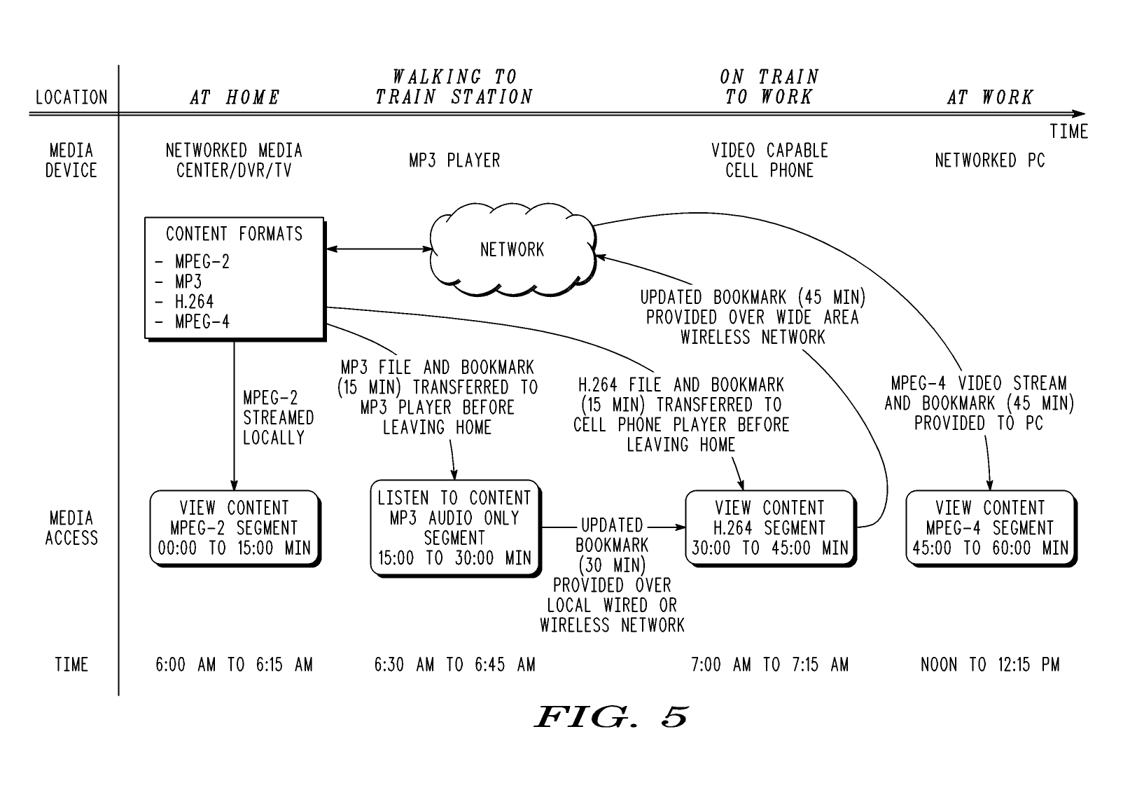

Referring now to FIG. 5, shown is a block diagram of yet another example scenario of accessing multimedia content across various multimedia devices using dynamic media bookmarks. This particular scenario involves the end user initially receiving multimedia content, e.g., a 1-hour video program, at home via an end user content access device, e.g., the end user's networked media center. For example, the video program is streamed from a content source network to the end user's networked media center in one or more suitable formats.

Using the television connected to the end user's networked media center, at 6:00 AM, the end user views a first portion of the video program, e.g., the first 15 minutes of the video program, from 6:00 AM to 6:15 AM, in a suitable format, such as MPEG-2. After viewing the first 15 minutes of the video program, the end user instructs the networked media center to terminate access to the video program and to bookmark the video program at the point between the 15-minute segment just viewed and the remaining 45 minutes of the video program not yet viewed.

The end user instructs the networked media center to transfer a copy of the video program and the associated bookmark to two other content access devices. For example, the end user instructs the networked media center to transfer a copy of the video program and the associated bookmark from the networked media center to the end user's MP3 player, e.g., as an MP3 file in MP3 format. Also, the end user instructs the networked media center to transfer a copy of the video program and the associated bookmark to the end user's video-capable cellular telephone, e.g., as an H.264 file. Thus, the end user then can access and consume any portion of the video program, e.g., the unviewed (45 minute) portion of the video program, using the end user's MP3 player and/or the end user's cellular telephone.

The content transfers are performed in any suitable manner, e.g., wirelessly or via wired connections between the end user's networked media center and the MP3 player and between the end user's networked media center and the cellular telephone. Also, the video program is transferred to the MP3 player and the cellular telephone in formats suitable to be read and accessed by the respective content access devices. Thus, for example, the video program is transferred to the MP3 player as an MP3 file and to the cellular telephone as an H.264 file. Also, as before with previous examples, the end user can instruct the networked media center to transfer all or a portion of the video program and the associated bookmark to the network for subsequent access by other content access devices configured to connect to the network.

In this example, at 6:30 AM, the end user consumes (e.g., listens to) a second portion of the video program, e.g., the next 15 minutes of the video program, in audio form only, using the end user's MP3 player, e.g., from 6:30 AM to 6:45 AM. The end user then instructs the MP3 player to terminate access to the video program and to update the bookmark associated with the video program. In this manner, the MP3 player moves (updates) the bookmark from the point between the first 15 minutes and the remaining 45 minutes of the video program to the point between the first 30 minutes consumed (i.e., the first 15 minutes viewed previously using the end user's network media center and the next 15 minutes listened to using the end user's MP3 player) and the remaining 30 minutes yet to be consumed.

Next, in this example, at 7:00 AM, the end user consumes (e.g., views) a third portion of the video program, e.g., the next 15 minutes of the video program, e.g., from 7:00 AM to 7:15 AM, in a suitable format, e.g., H.264, using the end user's cellular telephone. Access to the beginning of the remaining 30-minute portion of the video program that had yet to be consumed was available immediately and automatically to the end user's cellular telephone because of the updated bookmark between the first 30 minutes, which were already consumed (first 15 minutes viewed using the end user's network media center and next 15 minutes listened to using the end user's MP3 player) and the remaining 30 minutes, which up until then had not been consumed.

Alternatively, since the end user only listened to the second 15 minutes of the video program, as opposed to viewing that second 15 minute segment, the end user may have chosen to view, or effectively re-consume, the 15 minute portion of the video program to which the end user already has listened along with the next 15 minutes (or other desired length of time) of the video program, which had yet to be viewed or otherwise consumed. In this manner, the end user may have chosen not to instruct the MP3 player to update the bookmark from the 15-45 minute point in the video program to the 30-30 minute point in the video program. Without the updated bookmark, the end user then could have viewed the next 30 minutes or other length of time of the video program, the first 15 minutes of which would have already been listened to by the end user via the end user's MP3 player.

Returning to example scenario, as shown, upon transferring the updated bookmark (30-30 minute point in the video program) from the end user's MP3 player to the end user's cellular telephone, the updated bookmark would remove or update the 15-45 minute bookmark previously transferred to the end user's cellular telephone from the end user's networked media center. Thus, in this manner, it should be understood that bookmarks can be updated not only by the end user device that just viewed or otherwise consumed a portion of the content, but also by the transfer of an updated bookmark from another content access device.

After the end user consumed the 30-45 15-minute portion of the video program using the end user's cellular telephone, the end user then instructs the cellular telephone to terminate access to the video program and to update the bookmark associated with the video program. In this manner, the bookmark is moved (updated) from the point between the 30-30 minute point in the video program to the 45-15 minute point in the video program. The end user also can instruct the cellular telephone to transmit or transfer the updated bookmark to the network, e.g., either alone or along with the video program or a copy of the video program, e.g., in any suitable manner.

In this example, at 12:00 noon, the end user consumes (e.g., views) the remaining 15-minute portion of the video program that had yet to be viewed, e.g., from 12:00 noon to 12:15 PM, in a suitable format, e.g., an MPEG-4 video stream, using the end user's networked computer at the end user's work location. As shown, the video program and the updated bookmark was available to the end user's networked computer, e.g., via an MPEG-4 stream from the network.

As with previous example scenarios, although the four example video program segments are each 15 minutes in length, it should be understood that such is not required. That is, any one or more of the video program segments can be any suitable length of time and do not have to be in any specific time period intervals, e.g., 10, 15 or 20 minute segments. Also, as before, the number of consuming and/or re-consuming segments (e.g., listening, viewing or replaying) of the multimedia content is not limited to any specific number.

As discussed previously herein, the methods, devices and systems described herein involve the generation and use of dynamic multimedia bookmarks to provide an end user with a seamless multimedia content viewing or other consumption experience. The use of multimedia bookmarks that are dynamically updatable allows an end user to maintain their place or position in the progression of viewing or otherwise accessing and consuming multimedia content across one or more multimedia accessing devices and/or accessing locations and/or content formats. In this manner, the end user is provided with a seamless content consumption experience.

The method shown in FIG. 2 may be implemented in a general, multi-purpose or single purpose processor. Such a processor will execute instructions, either at the assembly, compiled or machine-level, to perform that process. Those instructions can be written by one of ordinary skill in the art following the description of FIG. 2 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the methods, apparatus and systems for accessing multimedia content using dynamic media bookmarks herein described without departing from the spirit and scope of the invention as defined by the appended claims and their full scope of equivalents.

1. A computer program embodied in a computer-readable medium for accessing multimedia content on a local multimedia device, the program comprising:
instructions for receiving the multimedia content by the local multimedia device, the multimedia content capable of having a bookmark associated therewith, wherein the bookmark is representative of a relative position within the multimedia content;
instructions for determining whether the received multimedia content includes a bookmark associated therewith;
instructions for accessing the received multimedia content by the local multimedia device,
wherein, if the multimedia content includes a bookmark associated therewith, the local multimedia device accesses the multimedia content based on the bookmark; and
instructions for transmitting the multimedia content and any associated bookmarks by the local multimedia device to a remote multimedia device.

2. The program as recited in claim 1, further comprising instructions for generating a bookmark associated with the multimedia content, wherein the bookmark is based on a portion of the content that has not been accessed by the local multimedia device.

3. The program as recited in claim 1, further comprising instructions for updating an existing bookmark, wherein the updated bookmark is based on a portion of the multimedia content that has not been accessed by the local multimedia device.

4. The program as recited in claim 1, wherein one or more of the local multimedia device and the remote multimedia device is selected from the group consisting of a video processing device, a signal converter box, a signal decoder box, a residential gateway, a computer, a video receiver, a digital video recorder, a digital video disk recorder, a digital video server, a television, a wired content network, a wireless content network, a mobile telephone, a personal digital assistant (PDA) and a cellular telephone.

5. The program as recited in claim 1, wherein the bookmark is embedded into the multimedia content.

6. The program as recited in claim 1, wherein the bookmark is metadata associated with at least a portion of the multimedia content.

7. A system for accessing multimedia content, comprising:
at least one first multimedia device configured to receive and access multimedia content in at least one multimedia content format from a multimedia content source,
wherein the first multimedia device is configured to generate a first bookmark associated with a first portion of the multimedia content that has not been accessed by the user of the first multimedia device;
at least one second multimedia device coupled to receive and access multimedia content in at least one multimedia content format from a multimedia content source,
wherein the second multimedia device is configured to access multimedia content associated with the first bookmark and to generate a second bookmark associated with a portion of the multimedia content that has not been accessed by the user of the second multimedia device; and
a network coupled to the first multimedia device and the second multimedia device and configured to transfer multimedia content and multimedia content bookmarks between the first multimedia device and the second multimedia device.

8. The system as recited in claim 7, wherein at least one bookmark is transferred with the multimedia content being transferred from the first multimedia device to the at least one second multimedia device.

9. The system as recited in claim 7, wherein at least one bookmark is transferred from the first multimedia device to the second multimedia device independent of the multimedia content being transferred from the first multimedia device to the second multimedia device.

10. The system as recited in claim 7, wherein at least one of the bookmarks generated by a multimedia device is transferred from the multimedia device to the network and stored on the network.

11. The system as recited in claim 7, wherein at least one of the bookmarks is transferred from the multimedia device that generated the bookmark and stored on the network, and wherein the bookmark stored on the network is transferred from the network to a multimedia device accessing the multimedia content with which the bookmark is associated.

12. The system as recited in claim 7, wherein at least one of the bookmarks is embedded into the multimedia content with which the bookmark is associated.

13. The system as recited in claim 7, wherein at least one of the bookmarks is metadata associated with at least a portion of the multimedia content.

14. The system as recited in claim 7, wherein at least one of the first multimedia device and the second multimedia device is selected from the group consisting of a signal converter box, a signal decoder box, a residential gateway, a home networking device, a media server system, a digital video recorder, a computer, a mobile telephone, a cellular telephone, a personal digital assistant (PDA), a mobile multimedia device, and a handheld multimedia device.

15. The system as recited in claim 7, wherein one or more of the at least one multimedia content formats is selected from the group consisting of a format according to the Moving Pictures Experts Group (MPEG) 2 standard, a format according to the MPEG 4 standard, a format according to the H.26x line of coding standards, the MPEG-1 Audio Layer 3 (MP3) format.

16. The system as recited in claim 7, wherein the second bookmark further comprises an updated first bookmark.

17. A device for accessing multimedia content, comprising:
a processor configured to receive and access multimedia content in at least one multimedia content format from a multimedia content source,
wherein the processor includes an encoder/decoder for determining whether the received multimedia content is bookmarked and for bookmarking at least one portion of the multimedia content that has not been accessed by the processor; and
at least one memory element coupled to the processor for storing multimedia content received by the device,
wherein the processor is configured to access the multimedia content from the bookmarked portion of the multimedia content, and
wherein the processor is configured to transfer at least one of multimedia content and bookmarks associated with at least a portion of the multimedia content to at least one of a multimedia content network and at least one other multimedia content accessing device.

18. The device as recited in claim 17, wherein at least a portion of the processor is implemented in software executed by a computer.

19. The device as recited in claim 17, wherein at least a portion of the processor is implemented in hardware.

20. The device as recited in claim 17, wherein the encoder/decoder is configured to embed at least one bookmark into the multimedia content.

21. The device as recited in claim 17, wherein the encoder/decoder is configured to generate metadata associated with the portion of the multimedia content that has not been accessed by the processor multimedia content.
